(19) United States
(12) Patent Application Publication
(10) Pub. No.: US 2026/0365052 A1
(43) Pub. Date: Nov. 19, 2026

(54) CHARGING SYSTEM

(71) Applicants: Hyundai Motor Company, Seoul (KR); Kia Corporation, Seoul (KR)

(72) Inventors: Sang Heon LEE, Hwaseong-Si (KR); Jin Ho HWANG, Hwaseong-Si (KR)

(73) Assignees: Hyundai Motor Company, Seoul (KR); Kia Corporation, Seoul (KR)

(21) Appl. No.: 19/391,289

(22) Filed: Nov. 17, 2025

(30) Foreign Application Priority Data
May 14, 2025 (KR) 10-2025-0062734

(51) Int. Cl. B60L 53/16; B60B 7/14; B60L 53/35

(52) U.S. Cl. CPC B60L 53/16; B60B 7/14; B60L 53/35

(57) ABSTRACT

A charging system provides a charging electric power by electrically connecting a charging station to a connector of a wheel as the connector for charging a battery of a mobility vehicle is disposed on the wheel. Furthermore, a cover for protecting the connector is disposed on the wheel, and the charging station automates a process of mounting and separating the cover, so that convenience of charging is secured.

### CROSS REFERENCE TO RELATED APPLICATION

The present application claims priority to Korean Patent Application No. 10-2025-0062734, filed May 14, 2025, the entire contents of which are incorporated herein for all purposes by this reference.

### BACKGROUND

### Field of the Present Disclosure

The present disclosure relates to a charging system configured so that electric power is transmitted through a mobility vehicle and a charging station.

### Description of Related Art

An electric vehicle is developed as an alternative to a vehicle powered by petroleum based fuels such as gasoline. The electrically powered vehicle may eliminate or reduce exhaust pollutants that are emitted during the combustion process, and may reduce vehicle noise.

The electric vehicle is generally driven by a battery, and the battery is required to be charged periodically to continue an operation of the battery. Generally, the electric vehicle is charged where the vehicle is parked, such as an owner home, or a dedicated charging station in a predetermined location on the road.

The foregoing is intended merely to aid in the understanding of the background of the present disclosure, and is not intended to mean that the present disclosure falls within the purview of the related art that is already known to those skilled in the art.

### BRIEF SUMMARY

Accordingly, the present disclosure is directed to providing a charging system for providing charging electric power as a connector for charging a battery of a mobility vehicle is disposed on a wheel.

The technical problems to be solved by the present disclosure are not limited to the above-mentioned problems, and other problems which are not mentioned will be clearly understood by those skilled in the art from the following description.

To achieve the objective described above, according to various aspects of the present disclosure, there is provided a charging system including: a wheel including a connector electrically connected to a battery module, the wheel including a cover which covers the connector and which is disposed on the wheel so that the cover is configured for being attached to or detached from the wheel; an attachment and detachment unit configured for being moved toward the wheel, the attachment and detachment unit being configured to selectively attach or detach the cover, thereby separating the cover from the wheel or mounting the cover on the wheel; and a charging unit configured for being moved toward the wheel, the charging unit being configured to be electrically connected to the connector when the cover is separated from the wheel by the attachment and detachment unit.

According to various aspects of the present disclosure, the connector may be exposed outside by penetrating a center portion of the wheel, the cover may be formed so that the cover covers the connector, and the cover may be configured to cover the connector when the cover is disposed on the wheel.

According to various aspects of the present disclosure, a first fastening portion may be formed on a portion or a whole of a circumferential surface of a center portion of the wheel, a fastening end portion that extends to an external periphery of the center portion of the wheel may be formed on the cover, and a second fastening portion connected to the first fastening portion may be formed on the fastening end portion.

According to various aspects of the present disclosure, the attachment and detachment unit and the charging unit may be disposed in the charging station, the charging station may include a docking interface in which a movement position thereof is adjusted in a vertical direction or a horizontal direction, and the docking interface may include an adjustment space in which the attachment and detachment unit is disposed and may include a charging space in which the charging unit is disposed.

According to various aspects of the present disclosure, the attachment and detachment unit may include: an adjustment portion disposed in the adjustment space of the docking interface, the adjustment portion being configured for being moved in a direction facing the wheel; and a connection portion coupled to the adjustment portion and configured so that the cover is configured for being attached to or detached from the connection portion.

According to various aspects of the present disclosure, a first sensor configured for identifying a position of the cover may be disposed in the adjustment portion, and the docking interface may be configured to adjust a position according to the position of the cover identified through the first sensor so that the connection portion is matched with the cover.

According to various aspects of the present disclosure, the connection portion may be formed so that the connection portion closes the charging space when the connection portion is moved to the charging space by the adjustment portion, and may be configured to be coupled to the cover when the connection portion is moved toward the wheel by the adjustment portion.

According to various aspects of the present disclosure, the connection portion may be disposed on the adjustment portion so that the connection portion is configured for being rotated toward the wheel or the charging space of the docking interface, may be configured to close the charging space when the connection portion is moved to the charging space by the adjustment portion, and may be configured to be coupled to the cover when the connection portion is moved toward the wheel by the adjustment portion.

According to various aspects of the present disclosure, a first coupling portion may be formed on an external side surface of the cover, and a second coupling portion connected to the first coupling portion of the cover may be formed on the connection portion.

According to various aspects of the present disclosure, a second sensor configured to identify a position where the connection portion is configured for being coupled to the cover may be disposed in the connection portion, the connection portion may be disposed on the adjustment portion so that the connection portion is configured for being rotated in the vertical direction, and a rotation angle of the connection portion may be changed according to the position where the connection portion is configured for being connected to the cover, the position being identified by the second sensor.

According to various aspects of the present disclosure, the connection portion may be disposed on the adjustment portion so that the connection portion is configured for being rotated in the vertical direction, and a first fastening portion formed of threads may be formed on a circumferential surface of a center portion of the wheel. Furthermore, a fastening end portion that extends to an external periphery of the center portion of the wheel may be formed on the cover, and a second fastening portion fastened to the first fastening portion may be formed on the fastening end portion, so that the cover may be disposed on or separated from the wheel by an operation in which the connection portion is coupled to the cover and the connection portion is rotated.

According to various aspects of the present disclosure, the adjustment portion may include: a first movement member disposed in the adjustment space of the docking interface, the first movement member being configured for being moved in a direction facing the wheel; and a second movement member which is disposed on the first movement member so that the second movement member is configured for being rotated in the vertical direction and which extends to the charging space of the docking interface so that the connection portion faces the charging space.

According to various aspects of the present disclosure, a third sensor configured to identify a position of the connector may be disposed in the charging unit, and the docking interface may be configured to adjust a position of the charging unit according to the position of the connector identified through the third sensor.

According to various aspects of the present disclosure, the charging unit may be electrically connected to the connector as the charging unit is withdrawn from the charging space of the docking interface along a direction toward the connector and the charging unit is connected to the connector.

According to various aspects of the present disclosure, the wheel may be disposed in a mobility vehicle, and the mobility vehicle may be disposed with the battery module and an electric power conversion module, so that the battery module, the electric power conversion module, and the connector may be electrically connected to each other.

According to the charging system of the present disclosure, the charging system in which charging electric power is disposed by electrically connecting the charging station to the connector of the wheel as the connector for charging the battery of the mobility vehicle is disposed on the wheel is disposed.

Furthermore, the cover for protecting the connector is disposed on the wheel, and the charging station automates the process of mounting and separating the cover, so that convenience of charging is secured.

The effects that can be obtained from the present disclosure are not limited to the above-mentioned effects, and other effects not mentioned herein will be clearly understood by those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view exemplarily illustrating a mobility vehicle and a charging station according to an exemplary embodiment of the present disclosure;

FIG. 2 is a view exemplarily illustrating the mobility vehicle according to an exemplary embodiment of the present disclosure;

FIG. 3 is a view exemplarily illustrating a wheel of the mobility vehicle according to an exemplary embodiment of the present disclosure;

FIG. 4 is a view exemplarily illustrating both a connector and a cover of the wheel according to an exemplary embodiment of the present disclosure;

FIG. 5 is a view exemplarily illustrating an attachment and detachment unit and a charging unit according to an exemplary embodiment of the present disclosure;

FIG. 6 is a view exemplarily illustrating a charging system according to an exemplary embodiment of the present disclosure;

FIG. 7 is a view exemplarily illustrating a position adjustment of a docking interface in the charging system according to an exemplary embodiment of the present disclosure;

FIG. 8 is a view exemplarily illustrating a position adjustment of the attachment and detachment unit in the charging system according to an exemplary embodiment of the present disclosure;

FIG. 9 is a view exemplarily illustrating a state in which the attachment and detachment unit is coupled to the cover in the charging system according to an exemplary embodiment of the present disclosure;

FIG. 10 is a view exemplarily illustrating a state in which the cover is being separated from the wheel by the attachment and detachment unit in the charging system according to an exemplary embodiment of the present disclosure;

FIG. 11 is a view exemplarily illustrating a state in which the cover is separated from the wheel in the charging system according to an exemplary embodiment of the present disclosure;

FIG. 12 is a view exemplarily illustrating a state in which a position of the charging unit is adjusted to a position of the connector of the wheel in the charging system according to an exemplary embodiment of the present disclosure; and

FIG. 13 is a view exemplarily illustrating a state in which the charging unit and the connector are connected to each other in the charging system according to an exemplary embodiment of the present disclosure.

### DETAILED DESCRIPTION

Detailed description of known technologies will be omitted if it is determined that the detailed description of the known technologies obscures the embodiments of the present specification. Furthermore, the accompanying drawings are merely intended to easily describe the embodiments of the present specification, but the spirit and technical scope of the present specification is not limited by the accompanying drawings. It should be understood that the present specification is not limited to specific disclosed exemplary embodiments of the present disclosure, but includes all modifications, equivalents and substitutes included within the spirit and technical scope of the present disclosure. The foregoing disclosure is not intended to limit the present disclosure to the precise forms or particular fields of use disclosed. Accordingly, it is contemplated that various alternate embodiments and/or modifications to the present disclosure, whether explicitly described or implied herein, are possible in light of the present disclosure. Having thus described embodiments of the present disclosure, a person of ordinary skill in the art will recognize that changes may be made in form and detail without departing from the scope of the present disclosure.

In the foregoing specification, the present disclosure has been described with reference to specific embodiments. However, as one skilled in the art will appreciate, various embodiments included herein can be modified or otherwise implemented in various other ways without departing from the spirit and scope of the present disclosure. Accordingly, the present description is to be considered as illustrative and is for teaching those skilled in the art the manner of making and using various embodiments of the present disclosure. It is to be understood that the forms of disclosure herein shown and described are to be taken as representative embodiments. Equivalent elements, materials, processes, or steps may be substituted for those representatively illustrated and described herein. Expressions such as “including”, “comprising”, “incorporating”, “consisting of”, “have”, “is”, and so on used to describe and claim the present disclosure are intended to be construed in a non-exclusive manner, namely allowing for items, components or elements not explicitly described also to be present. Reference to the singular is also to be construed to relate to the plural.

Furthermore, various embodiments included herein are to be taken in the illustrative and explanatory sense and should in no way be construed as limiting of the present disclosure. All joinder references (e.g., attached, affixed, coupled, connected, and so on) are only used to aid the reader's understanding of the present disclosure, and may not generate limitations, as to the position, orientation, or use of the systems and/or methods included herein. Therefore, joinder references, if any, are to be construed broadly. Moreover, such joinder references do not necessarily infer those two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not generate any limitations, particularly as to the order, or preference, of any element, embodiment, variation and/or modification relative to, or over, another element, embodiment, variation and/or modification. That is, such expressions may be used to describe various elements, but the elements are not limited by the expressions. The expressions are used only for distinguishing one constituent element from another constituent element.

In the following description, the expressions “module” and “part” contained in terms of constituent components to be described will be selected or used together in consideration only of the convenience of writing the following specification, and the expressions “module” and “part” do not necessarily have different meanings or roles.

When a component is described as being “connected”, “coupled”, or “linked” to another component, that component may be directly connected, coupled, or linked to that other component. However, it should be understood that yet another component between each of the components may be present. In contrast, it should be understood that when a component is referred to as being “directly coupled” or “directly connected” to another component, there are no intervening components present.

Furthermore, “unit” or “control unit” included in the names of an internal configuration of the present disclosure generally refer to a controller that is configured to control a specific function and do not mean a generic function unit.

Furthermore, “controller” may include a communication device configured to communicate with another controller or a sensor to control a function assigned thereto, a memory configured to store an operating system, logic commands, and input and output information, and at least one processor configured to perform determination, calculation, and decision necessary to control the assigned function.

Any number or variety of components in any of the configurations described herein can be included in the present disclosure, as described herein. The components may include any combination of the features described herein, and can be disposed in any of the various configurations described herein. The structure and arrangement of components of the present disclosure, as well as the concepts regarding their use can apply not only to the specific examples discussed herein, but to any number of embodiments in any combination. Various examples of the present disclosure including some having various features in various arrangements are described below with reference to the drawings.

Hereinafter, various exemplary embodiments included in the present specification will be described in detail with reference to the accompanying drawings. In the present specification, the same or similar components will be denoted by the same or similar reference numerals, and a repeated description thereof will be omitted.

The present disclosure is provided to charge electric power to a mobility vehicle 10 parked in a charging station 400. The charging station 400 may be a house or a charging place, and the mobility vehicle 10 may be an electric vehicle disposed with a motor driven by electric power of a battery module 11.

The mobility vehicle 10 according to an exemplary embodiment of the present disclosure is disposed with a connector 110 which is for charging electric power and which is disposed on each wheel 100, and the connector 110 is exposed to the outside from the wheel 100, so that the connector 110 is configured for being electrically connected to a charging unit 300 disposed in the charging station 400.

Accordingly, the present disclosure provides a charging system in which the mobility vehicle 10 including the wheel 100 disposed with the connector 110 is configured to supply or receive electric power, the charging system being configured to share electric power between the mobility vehicle 10 and the charging station and to secure convenience of charging.

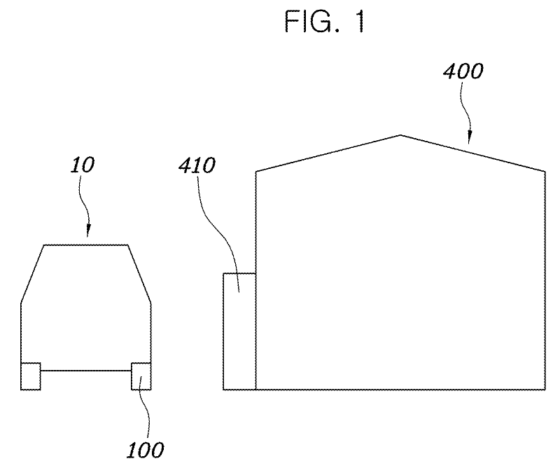

As illustrated in FIGS. 1, 2, 3, 4 and 5, the charging system according to an exemplary embodiment of the present disclosure may include: the wheel 100 including the connector 110 electrically connected to the battery module 11 and including a cover 120 disposed so that the cover 120 covers the connector 110 and is configured for being attached to or detached from the connector 110; an attachment and detachment unit 200 configured for being moved toward the wheel 100, the attachment and detachment unit 200 being configured to selectively attach or detach the cover 120, thereby separating the cover 120 from the wheel 100 or mounting the cover 120 on the wheel 100; and the charging unit 300 configured for being moved toward the wheel 100, the charging unit 300 being configured to be electrically connected to the connector 110 when the cover 120 is separated from the wheel 100 by the attachment and detachment unit 200.

The wheel 100 may be disposed on the mobility vehicle 10, and the attachment and detachment unit 200 and the charging unit 300 may be disposed on the charging station 400.

For example, as illustrated in FIG. 1, on the basis that the mobility vehicle 10 is parked where the charging station 400 is disposed, mounting and separation of the cover 120 and electrical connection of the connector 110 of the wheel 100 to the charging unit 300 may be automated by an interaction of the attachment and detachment unit 200 and the charging unit 300.

In an exemplary embodiment of the present disclosure, the wheel 100 is disposed in the mobility vehicle 10, and the battery module 11 and an electric power conversion module 12 are disposed in the mobility vehicle 10, so that the battery module 11, the electric power conversion module 12, and the connector 110 may be electrically connected to each other.

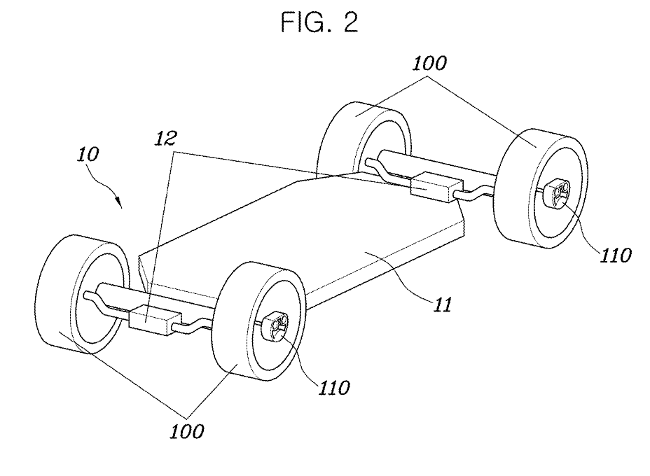

For example, as illustrated in FIG. 2, a plurality of wheels 100 may be disposed in the mobility vehicle 10, and a connector 110 may be disposed on each wheel 100. The mobility vehicle 10 may be disposed with the battery module 11 for storing electrical energy, and may be disposed with the electric power conversion module 12 for converting the electric power. The electric power conversion module 12 may be a device that converts alternating current electric power (AC) to direct current electric power (DC), and may typically be a converter. In the mobility vehicle 10 according to an exemplary embodiment of the present disclosure, the connector 110 may be disposed on both front and rear wheels, and the battery module 11, the electric power conversion module 12, and each connector 110 may be electrically connected to each other.

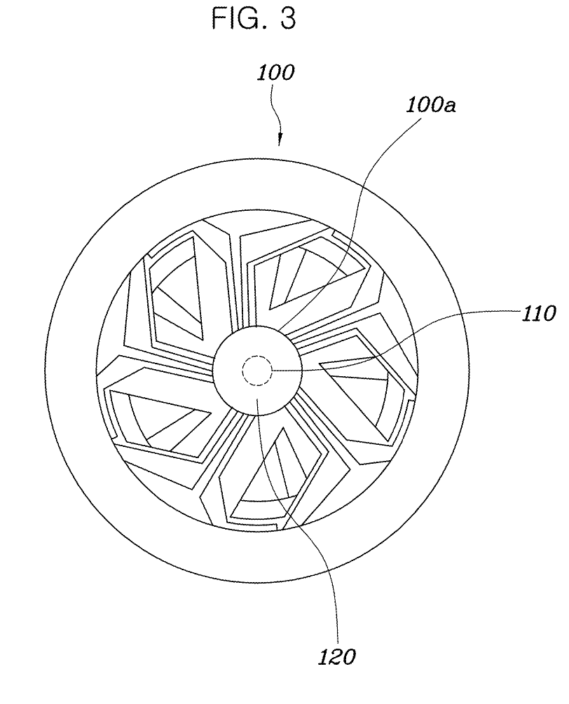

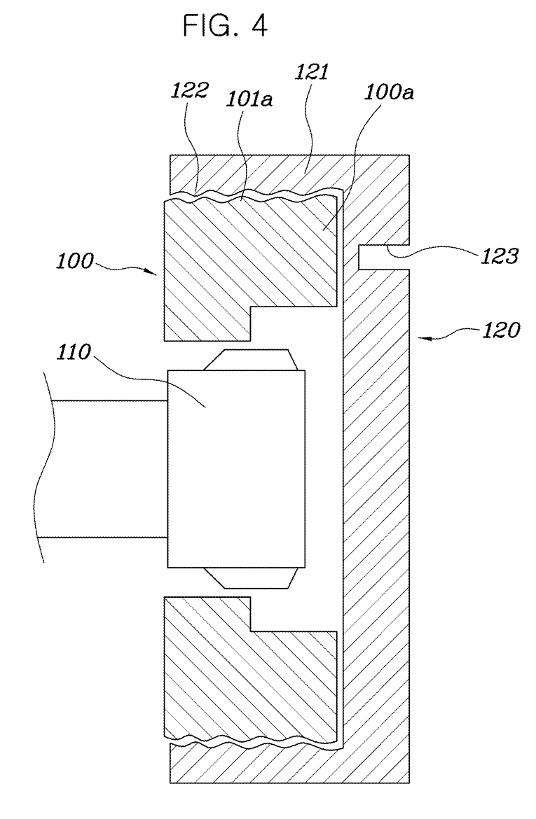

Meanwhile, as illustrated in FIGS. 3 and 4, the connector 110 is exposed to the outside through a center portion 100a of the wheel 100, the cover 120 is formed to cover the connector 110, and the cover 120 may cover the connector 110 by being disposed on the wheel 100.

The connector 110 may be disposed so that the connector 110 is exposed to the center portion 100a of the wheel 100 through the center portion of a knuckle of the wheel 100. Furthermore, the cover 120 may be formed so that the cover 120 covers up to the center portion 100a of the wheel 100 and also covers the connector 110, and may be disposed on the wheel 100.

Here, the center portion 100a of the wheel 100 may be a hub, and a shape of the cover 120 may be determined according to a shape of the center portion 100a of the wheel 100 and a plurality of spokes.

Furthermore, the connector 110 may be configured so that the connector 110 is fixed to the knuckle of the wheel 100 and is disposed to penetrate the center portion 100a of the wheel 100 so that the connector 110 does not interfere with a rotation of the wheel 100. Furthermore, the connector 110 may be configured so that the connector 110 is connected to the center portion 100a of the wheel 100 and is rotated with the wheel 100.

Meanwhile, to mount the wheel 100 and the cover 120, a first fastening portion 101a may be formed on a portion or a whole of a circumferential surface of the center portion 100a of the wheel 100, a fastening end portion 121 that extends toward an outside of the center portion 100a of the wheel 100 may be formed on the cover 120, and a second fastening portion 122 connected to the first fastening portion 101a may be formed on the fastening end portion 121.

That is, the cover 120 may be formed so that the cover 120 covers the center portion 100a of the wheel 100, and may be disposed so that the cover 120 covers the center portion 100a of the wheel 100 through the fastening end portion 121 that extends from an external end portion of the cover 120 toward an external periphery of the center portion 100a of the wheel 100. The second fastening portion 122 is formed on the fastening end portion 121 of the cover 120, and the first fastening portion 101a is formed on the center portion 100a of the wheel 100, so that the first fastening portion 101a and the second fastening portion 122 are fastened to each other, thereby fixing the cover 120 to the wheel 100. Here, the first fastening portion 101a and the second fastening portion 122 may be fastened to each other by at least one fastening method selected from a groove fastening method, a protrusion fastening method, a slot fastening method, a screw fastening method, and a forced-fitting structure method, or various other fastening structures may be applied.

Accordingly, as the first fastening portion 101a is formed on the external periphery of the center portion 100a of the wheel 100 and the cover 120 includes the second fastening portion 122 formed along an internal periphery of the fastening end portion 121, the cover 120 is configured for being disposed on the wheel 100 by coupling the first fastening portion 101a and the second fastening portion 122 to each other.

Meanwhile, the attachment and detachment unit 200 and the charging unit 300 of the present disclosure may be disposed in the charging station 400.

The charging station 400 may be a house or a charger, and may be a place where electric power is disposed.

Such a charging station 400 may include a docking interface 410 in which a movement position is adjusted in a vertical direction or a horizontal direction thereof.

The docking interface 410 may be configured so that at least one of a rail, a roller, a link arm, a linear actuator, and a magnetic is applied to the charging station 400 so that the docking interface 410 is moved in the charging station 400. Each embodiment of the present disclosure is exemplary, and is not limited thereto. Furthermore, a structure in which one portion moves vertically and horizontally from another portion may be applied in various other embodiments.

The docking interface 410 may include an adjustment space 411 in which the attachment and detachment unit 200 is disposed, and may include a charging space 412 in which the charging unit 300 is disposed.

In the docking interface 410, since the adjustment space 411 and the charging space 412 are separated from each other, interference between the attachment and detachment unit 200 disposed in the adjustment space 411 and the charging unit 300 disposed in the charging space 412 may be prevented, and management of the attachment and detachment unit 200 and the charging unit 300 may be conveniently performed. The charging unit 300 is a device in which electric power is disposed, and various safety devices including a sealing mechanism may be disposed in the charging space 412.

The attachment and detachment unit 200 and the charging unit 300 may be moved together according to a position to which the docking interface 410 is moved, and may be adjusted so that the attachment and detachment unit 200 is matched with the cover 120 and the charging unit 300 is matched with the connector 110 of the wheel 100 according to a movement position of the docking interface 410.

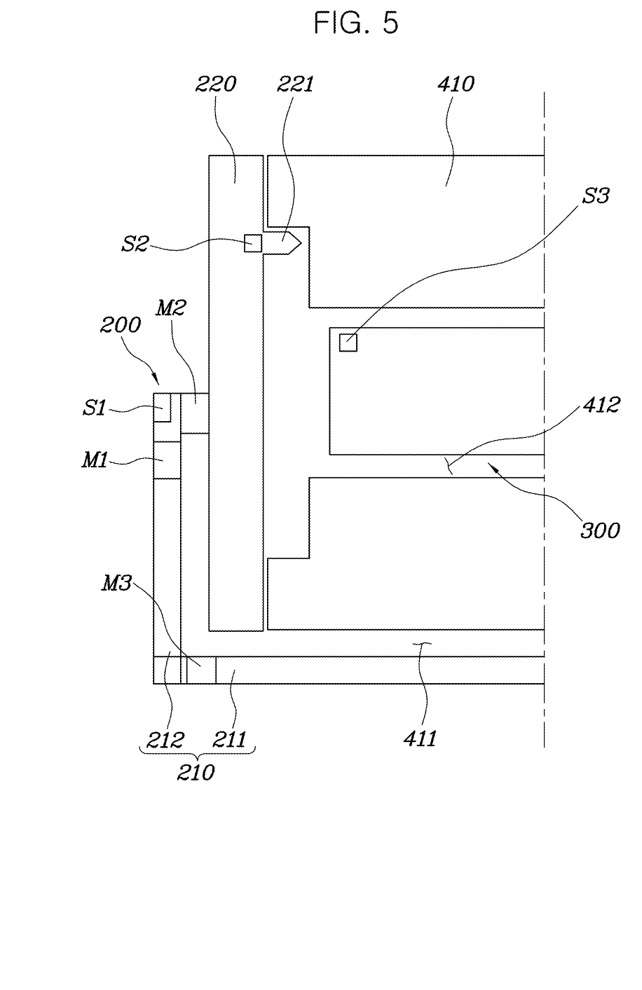

Meanwhile, as illustrated in FIG. 5, the attachment and detachment unit 200 may be formed of an adjustment portion 210 and a connection portion 220. The adjustment portion 210 may be disposed in the adjustment space 411 of the docking interface 410 and may be configured to be moved in a direction facing the wheel 100. Furthermore, the connection portion 220 may be disposed on the adjustment portion 210 and may be configured to be coupled to the cover 120 so that the cover 120 is configured for being attached to or detached from the adjustment portion 210.

That is, the adjustment portion 210 may be configured so that the adjustment portion 210 is withdrawn to the outside from the adjustment space 411 of the docking interface 410 or is introduced into the adjustment space 411. Such an adjustment portion 210 may be configured so that the adjustment portion 210 is rectilinearly moved in the adjustment space 411, and may be configured so that the connection portion 220 is moved toward the wheel 100 by varying a length of the adjustment portion 210.

For example, at least one structure selected from a rail structure, a belt structure, a telescopic structure, and a linear motor connection structure may be applied to the adjustment portion 210, so that the adjustment portion 210 may be configured so that the adjustment portion 210 is moved from the adjustment space 411 along a direction toward the wheel 100. Such embodiment of the present disclosure is exemplary, and the present disclosure is not limited thereto. Since a structure that extends in a longitudinal direction thereof corresponds to various known technologies, a detailed description thereof will be omitted.

The connection portion 220 is disposed on the adjustment portion 210, and is moved together with the adjustment portion 210. The connection portion 220 is configured so that the cover 120 is configured for being attached to or detached from the connection portion 220. Therefore, when the connection portion 220 is coupled to the cover 120, the connection portion may separate the cover 120 from the wheel 100 or may mount the cover 120 on the wheel 100 according to a movement position of the adjustment portion 210. A separate clamping or jig may be disposed on the connection portion 220 so that the cover 120 is configured for being attached to or detached from the connection portion 220.

In an exemplary embodiment of the present disclosure, the mounting and separation of the cover 120 by use of the attachment and detachment unit 200, and the electrical connection of the connector 110 by use of the charging unit 300 are described in detail as follows.

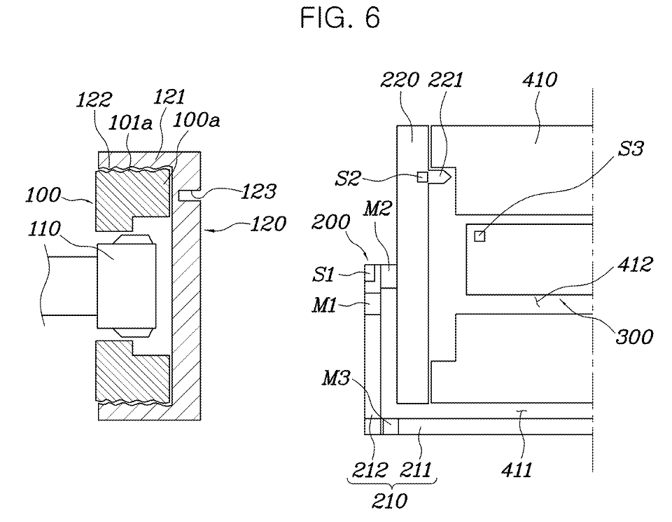

As illustrated in FIG. 6, a first sensor S1 for identifying a position of the cover 120 is disposed in the adjustment portion 210, and the docking interface 410 may adjust a position so that the connection portion 220 is matched with the cover 120 by adjusting a position of the connection portion 220 to the position of the cover 120, the position being identified through the first sensor S1.

Here, at least one sensor selected from an optical sensor, a magnetic sensor, an ultrasonic sensor, and a vision sensor may be applied to the first sensor S1, and the first sensor S1 may identify the position of the cover 120, thereby being configured for determining a state in which the connection portion 220 and the cover 120 are configured for being connected to each other. Furthermore, a separate sensor responding to the first sensor S1 may be further disposed in the cover 120 to increase a position identification accuracy of the first sensor S1.

The first sensor S1 may transmit position information of the cover 120 to a controller, the controller may check a matching state of the cover 120 and the connection portion 220 based on the information input through the first sensor S1, and the controller may be configured for controlling each device including the docking interface 410.

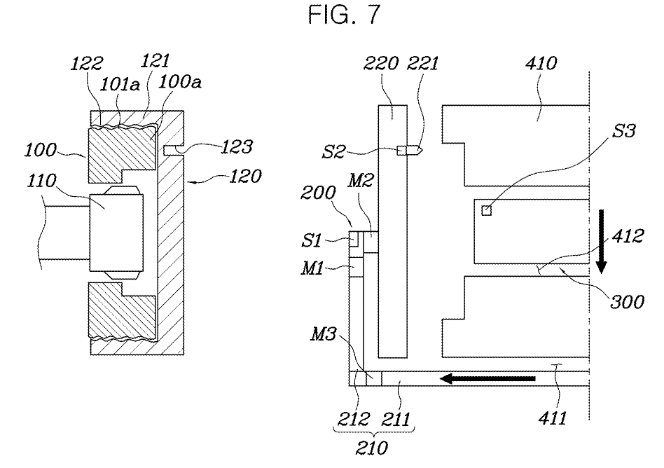

That is, the docking interface 410 may be controlled by receiving a signal input from the controller. As illustrated in FIG. 6, when position information of the connection portion 220 input through the first sensor S1 and position information of the cover 120 do not match, the position of the docking interface 410 may be adjusted as illustrated in FIG. 7 so that the connection portion 220 and the cover 120 are aligned in a straight line. The controller may be disposed in the charging station 400, may receive information from each sensor, may be configured for controlling each device including the docking interface 410, and may be configured for controlling the mobility vehicle 10 by communicating with the mobility vehicle 10.

Meanwhile, the connection portion 220 may be formed so that the connection portion 220 closes the charging space 412 when the connection portion 220 is moved to the charging space 412 by the adjustment portion 210, and may be configured so that the connection portion 220 is coupled to the cover 120 when the connection portion 220 is moved toward the wheel 100.

In an exemplary embodiment of the present disclosure, the adjustment portion 210 may be withdrawn toward the wheel 100 or may be inserted into the adjustment space 411 as the adjustment portion 210 is rectilinearly moved in the docking interface 410. Accordingly, the connection portion 220 may be moved toward the wheel 100 or may be moved toward the charging space 412 by moving together with the adjustment portion 210.

Furthermore, the connection portion 220 may be formed so that the connection portion 220 closes the charging space 412 when the connection portion 220 is moved toward the charging space 412. That is, the connection portion 220 may be formed so that the connection portion 220 covers the charging space 412, and may be further disposed with a structure for being coupled to the cover 120. As a structure for allowing the connection portion 220 to be coupled to the cover 120, a first coupling portion 123 is formed on an external side surface of the cover 120, and a second coupling portion 221 connected to the first coupling portion 123 of the cover 120 may be formed on the connection portion 220. Here, the first coupling portion 123 may be configured as a groove recessed in the cover 120, and the second coupling portion 221 may be configured as a protrusion which extends from the connection portion 220 and which is configured for being inserted into the first coupling portion 123.

Through this, in the docking interface 410, as the adjustment portion 210 is operated so that the adjustment portion 210 is withdrawn toward the wheel 100 and then the connection portion 220 is moved so that the connection portion 220 is in contact with the wheel 100, the second coupling portion 221 of the connection portion 220 is connected to the first coupling portion 123 of the cover 120, so that the connection portion 220 and the cover 120 are configured for being connected to each other.

Furthermore, in the docking interface 410, as the adjustment portion 210 is operated so that the adjustment portion 210 is inserted into the adjustment space 411 and then the connection portion 220 is moved away from the wheel 100, the cover 120 is configured for being separated from the wheel 100. Furthermore, as the connection portion 220 is formed to cover the charging space 412 in the docking interface 410, the connection portion 220 closes the adjustment space 411 when the adjustment portion 210 is moved so that the adjustment portion 210 is inserted into the adjustment space 411, so that the charging unit 300 may be protected.

Accordingly, as an exemplary embodiment of the present disclosure, the connection portion 220 may be disposed so that the connection portion 220 is configured for being rotated toward the wheel 100 or the charging space 412 of the docking interface 410, may close the charging space 412 as the connection portion 220 is moved toward the charging space 412 by the adjustment portion 210, and may be coupled to the cover 120 as the connection portion 220 is moved toward the wheel 100 by the adjustment portion 210.

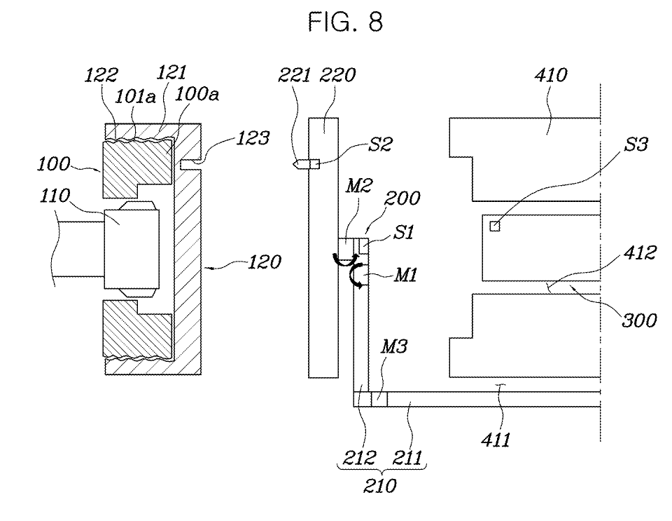

As illustrated in FIG. 8, the connection portion 220 may be disposed on the adjustment portion 210 so that the connection portion 220 is configured for being rotated on the adjustment portion 210. To the present end, at least one structure selected from a hinge connection structure, a coupling connection structure, and a gear connection structure may applied to the connection portion 220, so that the connection portion 220 is configured for being disposed on the adjustment portion 210 while the connection portion 220 is configured for being rotated on the adjustment portion 210. Furthermore, a first motor portion M1 may be disposed in the adjustment portion 210, and the first motor portion M1 may be connected to the connection portion 220, so that a rotation position of the connection portion 220 is configured for being adjusted. The first motor portion M1 may be a motor configured for being rotated in a forward direction and a reverse direction, and the connection portion 220 may be connected to the first motor portion M1 via a gear, so that the connection portion 220 is configured for being rotated according to whether the first motor portion M1 is operated. Such embodiments are exemplary, and a structure in which a position of a component that is configured for being rotated is changed corresponds to various known technologies, so that a detailed description thereof will be omitted.

Accordingly, as the connection portion 220 is configured for being rotated on the adjustment portion 210 and the connection portion 220 is configured for being rotated to face the charging space 412, the connection portion 220 may cover the charging space 412 and may protect the charging unit 300 in the charging space 412 when the adjustment portion 210 is moved in a direction in which the adjustment portion 210 is inserted into the charging space 412 of the docking interface 410.

Furthermore, as the connection portion 220 is rotated to face the wheel 100, the connection portion 220 may mount the cover 120 on the wheel 100 or may be coupled to the cover 120 disposed on the wheel 100 when the adjustment portion 210 is moved toward the wheel 100 in the charging space 412 of the docking interface 410.

Accordingly, since the connection portion 220 is configured so that the connection portion 220 is configured for being rotated on the adjustment portion 210, the operation of closing the charging space 412 and the operation of mounting or separating the cover 120 may be distinguished from each other, and the connection portion 220 is configured for performing each operation without interfering with the adjustment portion 210.

Meanwhile, a second sensor S2 configured for identifying a position where the connection portion 220 is configured for being coupled to the cover 120 may be disposed in the connection portion 220.

Here, at least one sensor selected from an optical sensor, a magnetic sensor, an ultrasonic sensor, and a vision sensor may be applied to the second sensor S2, and the second sensor S2 may identify the position of the cover 120, thereby being configured for determining a state in which the connection portion 220 and the cover 120 are configured for being connected to each other. Furthermore, a separate sensor responding to the second sensor S2 may be further disposed in the cover 120 to increase a position identification accuracy of the second sensor S2. The second sensor S2 may transmit position information of the cover 120 to the controller, and the controller may be configured for controlling each device including the docking interface 410 based on the information input through the second sensor S2.

Meanwhile, the connection portion 220 is disposed on the adjustment portion 210 so that the connection portion 220 is configured for being rotated in a vertical direction, and a rotation angle of the connection portion 220 may be changed according to a connectable position of the cover 120 identified through the second sensor S2.

To the present end, at least one structure selected from a hinge connection structure, a coupling connection structure, and a gear connection structure may applied to the connection portion 220, so that the connection portion 220 is configured for being disposed on the adjustment portion 210 while the connection portion 220 is configured for being rotated in the vertical direction on the adjustment portion 210. Furthermore, a second motor portion M2 may be disposed in the adjustment portion 210, and the second motor portion M2 may be connected to the connection portion 220, so that a rotation position of the connection portion 220 is configured for being adjusted. The second motor portion M2 may be a motor configured for being rotated in a forward direction and a reverse direction, and the connection portion 220 may be connected to the second motor portion M2 via a gear, so that the connection portion 220 is configured for being rotated according to whether the second motor portion M2 is operated. Such embodiments are exemplary, and a structure in which a position of a component that is configured for being rotated is changed corresponds to various known technologies, so that a detailed description thereof will be omitted.

Through this, the rotation angle of the connection portion 220 is changed according to a position where the connection portion 220 is configured for being coupled to the cover 120 identified through the second sensor S2, so that the connection portion 220 is configured for being coupled to the cover 120. In an exemplary embodiment of the present disclosure, the state in which the connection portion 220 and the cover 120 are configured for being connected to each other may be a state in which the first coupling portion 123 and the second coupling portion 221 are configured for being connected to each other as the second coupling portion 221 of the connection portion 220 and the first coupling portion 123 of the cover 120 are matched with each other.

That is, as the cover 120 is disposed on the wheel 100, the cover 120 is rotated with the wheel 100. Since the connection portion 220 is rotated in the adjustment portion 210 along the same direction as the rotation direction of the wheel 100, the first coupling portion 123 of the cover 120 and the second coupling portion 221 of the connection portion 220 are configured for being matched with each other.

Furthermore, according to an exemplary embodiment of the present disclosure in which the cover 120 and the wheel 100 are configured for being screw-fastened to each other, the connection portion 220 is disposed on the adjustment portion 210 so that the connection portion 220 is configured for being rotated in the vertical direction, the first fastening portion 101a including a circumferential surface thereof disposed with threads is formed on the center portion 100a of the wheel 100, and the second fastening portion 122 formed of threads is formed on the fastening end portion 121 that extends toward the external periphery of the center portion 100a of the wheel 100, so that the cover 120 is configured for being disposed on or separated from the wheel 100 by the operation in which the connection portion 220 is coupled to the cover 120 and the connection portion 220 is rotated.

Accordingly, as the first fastening portion 101a formed of threads is formed on the circumferential surface of the center portion 100a of the wheel 100 and the second fastening portion 122 configured for being screw-fastened to the first fastening portion 101a is formed on an internal side surface of the fastening end portion 121 of the cover 120, the cover 120 may be disposed on or separated from the wheel 100 by being rotated along the threads of each fastening portion through the rotation of the connection portion 220.

That is, as the connection portion 220 is coupled to the cover 120, the connection portion 220 and the cover 120 are rotated together when the connection portion 220 is rotated on the adjustment portion 210, so that the cover 120 is configured for being screw-fastened to or screw-released from the wheel 100 by being rotated from the wheel 100.

Meanwhile, the adjustment portion 210 may be formed of a first movement member 211 and a second movement member 212. The first movement member 211 is disposed in the adjustment space 411 of the docking interface 410 and is configured for being moved in a direction facing the wheel 100, and the second movement member 212 is configured for being disposed on the first movement member 211 so that the second movement member 212 is configured for being rotated in the vertical direction thereof. Furthermore, the second movement member 212 may extends to the charging space 412 of the docking interface 412 so that the connection portion 220 faces the charging space 412.

In the adjustment space 411 of the docking interface 410, at least one structure selected from a rail structure, a belt structure, a telescopic structure, and a linear motor connection structure may be applied to the first movement member 211, so that the first movement member 211 may be configured so that the first movement member 211 is moved from the adjustment space 411 along a direction toward the wheel 100. Such embodiment of the present disclosure is exemplary, and the present disclosure is not limited thereto. Since a structure that extends in a longitudinal direction thereof corresponds to various known technologies, a detailed description thereof will be omitted.

Furthermore, since the second movement member 212 is configured for being rotated on the first movement member 211, the connection portion 220 is configured for being disposed in the charging space 412 or may be moved away from the charging space 412. To the present end, a third motor portion M3 may be disposed in the first movement member 211, and the third motor portion M3 may be connected to the second movement member 212, so that the rotation of the second movement member 212 is configured for being adjusted. The third motor portion M3 may be a motor configured for being rotated in a forward direction and a reverse direction, and the second movement member 212 may be connected to the third motor portion M3 via a gear, so that the second movement member 212 is configured for being rotated according to whether the third motor portion M3 is operated. Such embodiments are exemplary, and a structure in which a position of a component that is configured for being rotated is changed corresponds to various known technologies, so that a detailed description thereof will be omitted.

Through this, the connection portion 220 may be disposed so that the position of the connection portion 220 is matched with the charging space 410 and then may close the charging space 412, or may be moved toward the wheel 100 and then may mount the cover 120 on the wheel 100 or detach the cover 120 from the wheel 100. Furthermore, when the connection portion 220 is moved so that the connection portion 220 is separated from the charging space 412, the charging unit 300 is configured for being moved toward the connector 110 of the wheel 100 without interfering with the connection portion 220 of the charging unit 300.

Meanwhile, a third sensor S3 configured for identifying a position of the connector 110 may be disposed in the charging unit 300.

Here, at least one sensor selected from an optical sensor, a magnetic sensor, an ultrasonic sensor, and a vision sensor may be applied to the third sensor S3, and the third sensor S3 may identify the position of the connector 110 of the wheel 100, thereby being configured for determining a state in which the charging unit 300 is configured for being connected to the connector 110. Furthermore, a separate sensor responding to the third sensor S3 may be further disposed in the connector 110 to increase a position identification accuracy of the third sensor S3. The third sensor S3 may transmit position information of the cover 120 to the controller, the controller may check a matching state of the charging unit 300 and the connector 110 based on the information input through the third sensor S3, and the controller may be configured for controlling each device including the docking interface 410.

The docking interface 410 may adjust the position of the charging unit 300 according to the position of the connector 110 identified through the third sensor S3. That is, in the docking interface 410, the position of the charging unit 300 is adjusted so that the position of the charging unit 300 is matched with the position of the connector 110 according to the position of the connector 110 identified through the third sensor S3, so that the charging unit 300 is configured for being electrically connected to the connector 110 when the charging unit 300 is withdrawn from the adjustment space 411 and is moved toward the wheel 100.

For example, at least one structure selected from a rail structure, a belt structure, a telescopic structure, and a linear motor connection structure may be applied to the charging unit 300, so that the charging unit 300 may be configured so that the charging unit 300 is moved in the charging space 412 along a direction toward the connector 110. Such embodiment of the present disclosure is exemplary, and the present disclosure is not limited thereto. Since a structure that extends in a longitudinal direction thereof corresponds to various known technologies, a detailed description thereof will be omitted.

The charging unit 300 and the connector 110 may be disposed with terminals that are electrically connected to each other, and shapes of the external periphery of the charging unit 300 and the connector 110 are matched with each other, so that a connection state is configured for being maintained. Furthermore, at least one structure selected from a hook structure, a latching structure, a snap fit structure, and a magnetic structure may be applied to connect the charging unit 300 and the connector 110 to each other, thereby being configured for maintaining the connection state.

In the following description, according to an exemplary embodiment of the present disclosure described above, a process of separating the cover 120 from the wheel 100 and a process of connecting the connector 110 to the charging unit 300 will be described. Each device including the docking interface 410 described later is controlled by the controller, and each sensor may transmit detecting information to the controller.

FIG. 6 shows a state in which the mobility vehicle 10 enters the charging station 400 and the wheel 100 of the mobility vehicle 10 is matched with the docking interface 410.

Here, when position information of the connection portion 220 input through the first sensor S1 and position information of the cover 120 do not match, the position of the docking interface 410 may be adjusted as illustrated in FIG. 7 so that the connection portion 220 and the cover 120 are aligned in a straight line.

Accordingly, as illustrated in FIG. 8, the connection portion 220 of the attachment and detachment unit 200 is rotated on the adjustment portion 210 and is disposed so that the connection portion 220 faces the cover 120 disposed on the wheel 100. Furthermore, whether the connection portion 220 is configured for being coupled to the cover 120 is determined based on the information input through the second sensor S2. Accordingly, when it is determined that the connection portion 220 is in a state in which the connection portion 220 is not capable of being coupled to the cover 120, the connection portion 220 is rotated from the adjustment portion 210 and the state of the connection portion 220 is changed to a state in which the connection portion 220 is capable of being coupled to the cover 120. Here, the state in which the connection portion 220 is capable of being coupled to the cover 120 may be the state in which the first coupling portion 123 and the second coupling portion 221 are configured for being connected to each other as the second coupling portion 221 of the connection portion 220 and the first coupling portion 123 of the cover 120 are matched with each other.

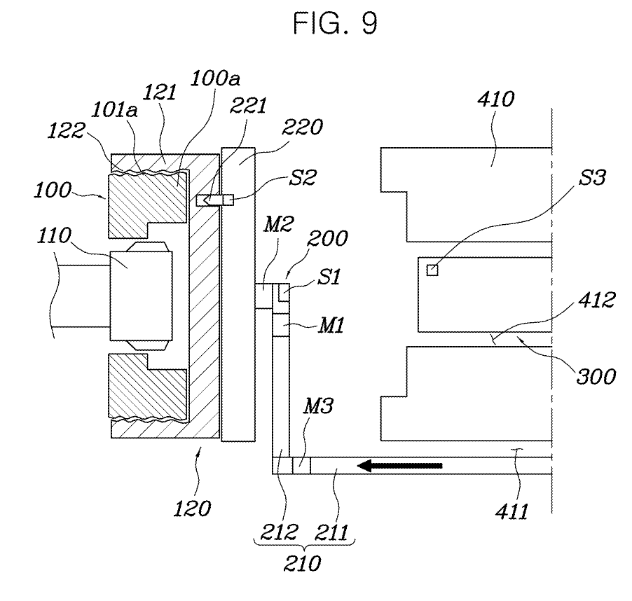

In the present manner, when the state in which the connection portion 220 and the cover 120 are capable of being connected is adjusted, the adjustment portion 210 is withdrawn from the docking interface 410 and is moved toward the wheel 100, and the connection portion 220 is moved together with the adjustment portion 210 and is coupled to the cover 120 as illustrated in FIG. 9. The present state may be a state in which the second coupling portion 221 of the connection portion 220 is inserted into the first coupling portion 123 of the cover 120.

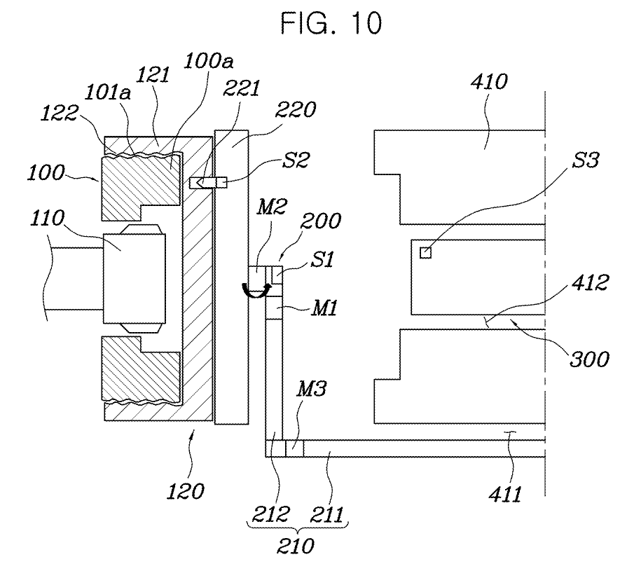

Accordingly, as illustrated in FIG. 10, when the connection portion 220 is rotated on the adjustment portion 210, the cover 120 is rotated with the connection portion 220, and the cover 120 is configured for being screw-released from the wheel 100 as the cover 120 was screw-fastened to the center portion 100a of the wheel 100.

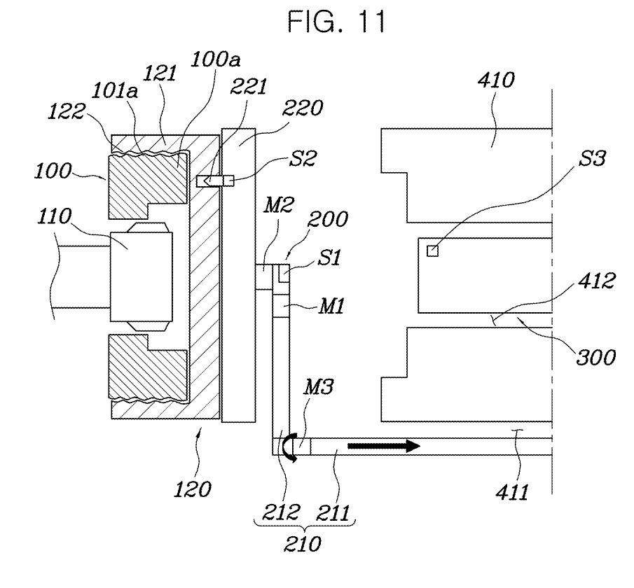

In the present manner, as illustrated in FIG. 11, when the cover 120 is separated from the wheel 100, the adjustment portion 210 is inserted into the adjustment space 411 of the docking interface 410 so that the cover 120 is moved away from the wheel 100, and the second movement member 212 that forms the adjustment portion 210 is rotated from the first movement member 211, the connection portion 220 is configured for being moved away from a space between the wheel 100 and the charging space 412 of the docking interface 410.

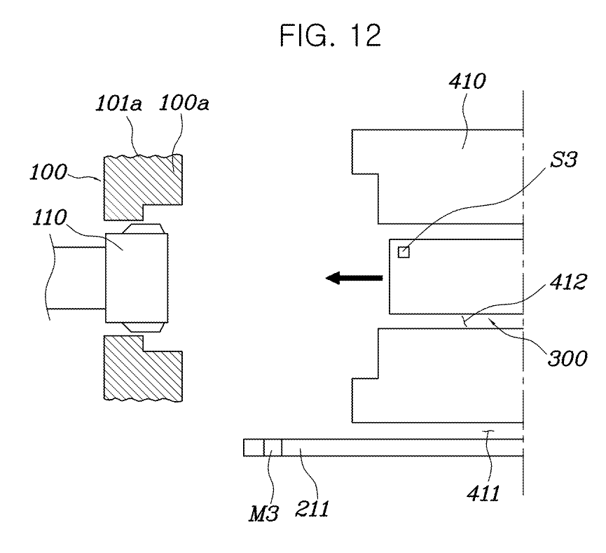

Subsequently, as illustrated in FIG. 12, whether the charging unit 300 is configured for being connected to the connector 110 is determined based on the information input through the third sensor S3, and the position of the docking interface 410 may be adjusted when the charging unit 300 is in the state in which the charging unit 300 is not configured for being connected to the connector 110.

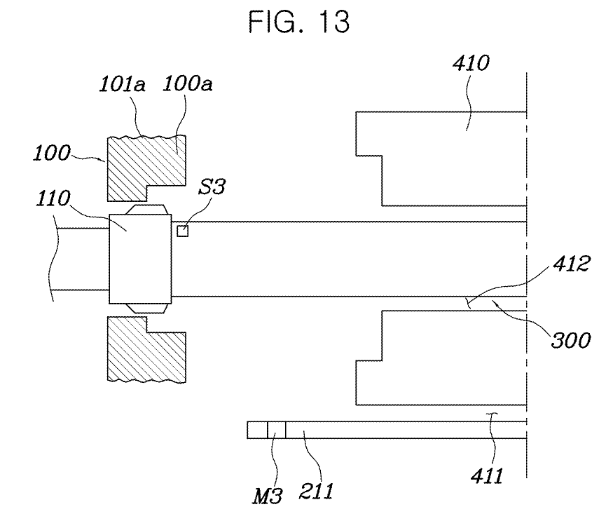

In the present manner, as illustrated in FIG. 13, when the state in which the charging unit 300 is configured for being connected to the connector 110 is adjusted, the charging unit 300 is withdrawn from the docking interface 410 and is connected to the connector 110, so that electric power is configured for being disposed to the battery module 11 of the mobility vehicle 10.

The checking of the position of each component through each sensor and the control of each component including the docking interface 410 may be integrally controlled by the controller.

Furthermore, a process of disconnecting the charging unit 300 from the connector 110 and a process of mounting the cover 120 on the wheel 100 again may be performed by performing the above-described processes in the reverse order.

According to the charging system of the present disclosure, as the connector 110 for charging the battery of the mobility vehicle 10 is disposed on the wheel 100, charging electric power is supplied to the battery by connecting the charging station 400 to the connector 110 of the wheel 100.

Furthermore, the wheel 100 is disposed with the cover 120 for protecting the connector 110, and the charging station 400 automates the process of mounting and separating the cover 120 and the charging process, so that convenience of charging is secured.

Although exemplary embodiments of the present disclosure have been described herein, it is understood that the present disclosure should not be limited to these exemplary embodiments and that various changes and modifications can include one ordinary skilled in the art within the spirit and scope of the present disclosure.

What is claimed is:

1. A charging system comprising:
a wheel comprising a connector and a cover, the connector being electrically connected to a battery module, the cover covering the connector and being disposed on the wheel so that the cover is configured for being attached to or detached from the wheel;
an attachment and detachment unit being movable toward the wheel to selectively attach the cover to the wheel or detach the cover from the wheel, thereby separating the cover from the wheel or mounting the cover on the wheel; and
a charging unit being movable toward the wheel and being configured to be electrically connected to the connector based on that the cover is separated from the wheel by the attachment and detachment unit.

2. The charging system of claim 1, wherein the connector is exposed outside by penetrating a center portion of the wheel and the cover covers the connector based on that the cover is disposed on the wheel.

3. The charging system of claim 1,
wherein the wheel includes a first fastening portion on a part or a whole of a circumferential surface of a center portion of the wheel,
wherein the cover includes a fastening end portion that extends to an external periphery of the center portion of the wheel, and
wherein the fastening end portion includes a second fastening portion configured to be connected to the first fastening portion.

4. The charging system of claim 1,
wherein the attachment and detachment unit and the charging unit are disposed in a charging station,
wherein the charging station includes a docking interface in which a movement position thereof is adjusted in a vertical direction or a horizontal direction, and
wherein the docking interface includes an adjustment space in which the attachment and detachment unit is disposed, and a charging space in which the charging unit is disposed.

5. The charging system of claim 4, wherein the attachment and detachment unit includes:
an adjustment portion disposed in the adjustment space of the docking interface and being configured for being moved in a direction facing the wheel; and
a connection portion coupled to the adjustment portion and selectively coupled to the cover so that the cover is configured for being attached to or detached from the connection portion.

6. The charging system of claim 5, further comprising a first sensor disposed in the adjustment portion and identifying a position of the cover,
wherein the docking interface is configured to adjust a position thereof based on the position of the cover identified through the first sensor so that the connection portion is matched with the cover.

7. The charging system of claim 5, wherein the connection portion closes the charging space based on that the connection portion is moved to the charging space by the adjustment portion, and is coupled to the cover based on that the connection portion is moved toward the wheel by the adjustment portion.

8. The charging system of claim 5, wherein the connection portion is coupled to the adjustment portion to be rotated toward the wheel or the charging space of the docking interface, closes the charging space based on that the connection portion is moved to the charging space by the adjustment portion, and is coupled to the cover based on that the connection portion is moved toward the wheel by the adjustment portion.

9. The charging system of claim 5,
wherein the cover includes a first coupling portion formed on an external side surface of the cover, and
wherein the connection portion includes a second coupling portion configured to be connected to the first coupling portion of the cover.

10. The charging system of claim 5, further comprising a second sensor disposed in the connection portion and identifying a position where the connection portion is capable of being coupled to the cover,
wherein the connection portion is disposed on the adjustment portion to be configured for being rotated in the vertical direction, and a rotation angle of the connection portion is changed based on the position where the connection portion is capable of being coupled to the cover, the position being identified by the second sensor.

11. The charging system of claim 5,
wherein the connection portion is disposed on the adjustment portion to be rotated in the vertical direction,
wherein a first fastening portion formed of threads is formed on a circumferential surface of a center portion of the wheel, and
wherein a fastening end portion that extends to an external periphery of the center portion of the wheel is formed on the cover, and a second fastening portion fastened to the first fastening portion is formed on the fastening end portion, so that the cover is disposed on or separated from the wheel by an operation in which the connection portion is coupled to the cover and is rotated.

12. The charging system of claim 5, wherein the adjustment portion includes:
a first movement member moveably disposed in the adjustment space of the docking interface and being configured for being moved in a direction facing the wheel; and
a second movement member which is coupled to the first movement member to be configured for being rotated in the vertical direction and extend to the charging space of the docking interface so that the connection portion faces the charging space.

13. The charging system of claim 4, further comprising a third sensor disposed in the charging unit and identifying a position of the connector,
wherein the docking interface is configured to adjust a position of the charging unit based on the position of the connector identified through the third sensor.

14. The charging system of claim 4, wherein the charging unit is electrically connected to the connector as the charging unit is withdrawn from the charging space of the docking interface along a direction toward the connector and the charging unit is connected to the connector.

15. The charging system of claim 1, wherein the wheel is disposed in a mobility vehicle, and the mobility vehicle is disposed with the battery module and an electric power conversion module, so that the battery module, the electric power conversion module, and the connector are electrically connected to each other.

16. A vehicle comprising:
a wheel comprising a connector and a cover, wherein the connector is selectively covered by the cover,
a battery module and an electric power conversion module, wherein the battery module, the electric power conversion module, and the connector are electrically connected to each other,
wherein the cover is configured for being attached to or detached from the wheel to selectively cover the connector.

17. A charging station comprising:
an attachment and detachment unit being movable toward a wheel of a vehicle including a cover to selectively attach the cover to the wheel or detach the cover from the wheel, thereby separating the cover from the wheel or mounting the cover on the wheel; and
a charging unit being movable toward the wheel and being configured to be electrically connected to the connector based on that the cover is separated from the wheel by the attachment and detachment unit.

18. The charging station of claim 17, further comprising:
an adjustment portion disposed in an adjustment space in a docking interface of the charging station and being configured for being moved in a direction facing the wheel; and
a connection portion coupled to the adjustment portion and selectively coupled to the cover so that the cover is configured for being attached to or detached from the connection portion.

19. The charging station of claim 18, wherein the connection portion is disposed on the adjustment portion to be rotated toward the wheel or a charging space of the docking interface, closes the charging space based on that the connection portion is moved to the charging space by the adjustment portion, and is coupled to the cover based on that the connection portion is moved toward the wheel by the adjustment portion.

20. The charging station of claim 18, wherein the adjustment portion includes:
a first movement member moveably disposed in the adjustment space of the docking interface and being configured for being moved in a direction facing the wheel; and
a second movement member which is disposed on the first movement member to be configured for being rotated in a vertical direction and extend to the charging space of the docking interface so that the connection portion faces the charging space.
